(19) United States
(12) Patent Application Publication
(10) Pub. No.: US 2003/0222368 A1
(43) Pub. Date: Dec. 4, 2003

(54) Flexible lightweight concrete form

(76) Inventor: Perry J. Gilmour, LaCenter, WA (US)

Correspondence Address: MARGER JOHNSON & MCCOLLOM PC, 1030 SW MORRISON STREET, PORTLAND, OR, 97205, US

(21) Appl. No.: 10/410,864

(22) Filed: Apr. 9, 2003

Related U.S. Application Data
(60) Provisional application No. 60/372,190, filed on Apr. 11, 2002.

(51) Int. Cl. B28B 7/00

(52) U.S. Cl. 264/31; 249/155

(57) ABSTRACT

This invention relates to a reusable concrete form which is utilized to produce a concrete structure. The concrete form typically comprises a concrete form body portion, which is generally flexible in construction. The concrete form body portion is configurable during use to define a substantially circular or arcuate-shaped workspace. At least one fastener is attached to the concrete form body portion. In an assembled position, the fastener is interlockingly engaged so that the concrete form body portion defines a circular or arcuate-shaped workspace. In the disassembled position, the fastener is disengaged, and the concrete form is in a flattened configuration which is readily storable.

### RELATED APPLICATION

This application claims priority from U.S. Provisional Application Serial No. 60/372,190, filed Apr. 11, 2002.

### BACKGROUND OF THE INVENTION

Concrete footings, columns and post bases are constructed employing a concrete form into which the flowable concrete is poured. These concrete structures require the use of forms which are circular or arcuate in configuration. When the poured concrete hardens, the form is removed, and circular or arcuate-shaped concrete structure remains in place. Concrete forms which contend that they produce concrete structures which are circular or arcuate-shaped that are commercially available today include, for example, paper impregnated forms, such as Sonotube products, and sheet metal forms.

A number of problems exist with the concrete forms presently in the marketplace. They are generally not reusable for subsequent concrete pours, and are therefore are costly to use.

They are typically manufactured of a material which has limited strength and/or integrity. For example, some concrete forms are made of paper and are disposable. If the form is made of sheet metal, it is inflexible, easily deformable and doesn't readily return to its original circular or arcuate shape after use. Thus, as a practical matter, subsequent use is questionable at best. They can't readily form a seamless concrete structure.

There is another problem which is related to the use of material which has limited strength and/or integrity. Paper forms become contorted in use. Sheet metal forms become deformed during handling. In either case, the creation of a concrete structure having a constant, smooth circular or arcuate shape becomes hindered.

Prior art concrete forms are limited in size and adjustability because of the materials of construction employed and the design which is of a unitary functional construction. For similar reasons, they are also limited in length and width. Larger and/or wider forms are too complicated to handle and maneuver. They are also complex to assemble and difficult to maintain in an assembled condition.

These prior art concrete forms do not store efficiently and are therefore storage space limited. They are not readily storable because they are in an assembled state ready for use. They occupy relatively large areas of storage space.

These commercially forms do not have a substantially non-stick inner surface with respect to the concrete structure. Therefore, they are not easily removable from about the finally-formed concrete structure. They do not permit a smooth pour of concrete into the concrete form structure.

They are not readily leveled or braced with respect to the underlying surface on which they are supported, typically an undulating building site. Additional leveling or bracing is therefore quite costly. Also, they require a concrete pad to be poured in order to support a series of concrete footings. End users will thus incur substantial additional expense for concrete and labor to create this underlying support pad.

Prior art paper or sheet metal forms must be stored indoors or taken to a construction site under a covering. If not they will be not survive intact the severe weather conditions. Because of their inflexible nature, conventional concrete forms cannot readily be installed about existing structural framework. They are also not easily adjustable to form concrete structures of varying diameters or radii or concrete structures having multiple heights.

Finally, they don't readily accept fasteners, such as nails or screws, for adding auxiliary structural items to the concrete form. This is because they are fabricated of a unitary structure which is not accommodating in nature.

### SUMMARY OF THE INVENTION

The concrete forms of the present invention have a number of advantages, and solve a number of prior art problems, as compared to conventionally available concrete forms.

Unlike certain prior art concrete forms, the concrete forms of the present invention are reusable, not disposable, and can be employed for subsequent concrete pours. Therefore, they are much less costly to use.

The subject forms are of unlimited size and adjustability and can comprise a plurality of diameters/radial lengths and a plurality of heights/radial widths.

Prior art concrete forms are restricted in all these areas of size and adjustability.

They are typically manufactured of a material which has limited strength and/or integrity.

The subject concrete forms are flexible, not easily deformable and readily return to their original circular or arcuate shape after use. All of these properties help facilitate subsequent use of the concrete form of this invention. They also form a seamless concrete structure and one having a constant, smooth circular or arcuate shape.

The concrete forms of this invention store efficiently and are therefore not storage space limited. They are readily storable when they are in a disassembled state ready in a substantially flattened configuration. They occupy relatively minimum areas of storage space.

The concrete forms claimed herein have a substantially non-stick inner surface with respect to the concrete structure produced there within. Therefore, they are easily removable from about the finally-formed concrete structure.

Accordingly, they permit a smooth pour of concrete into the concrete form structure.

The present concrete forms are readily leveled or braced with respect to the underlying surface on which they is supported, typically an undulating building site. Additional leveling or bracing can therefore be avoided without additional cost. Also, they do not require a concrete pad to be poured in order to support a series of concrete footings produced using these concrete forms. End users will not have to incur substantial additional expense for concrete and labor to create this underlying support pad.

The subject concrete forms do not have to be stored indoors or taken to a construction site under a covering. They are able to survive intact severe weather conditions. Because of their flexible nature, these concrete forms can readily be installed about existing structural framework. They are also easily adjustable to form concrete structures of varying diameters or radii or concrete structures having multiple heights.

Finally, the concrete forms of this invention can readily accept fasteners, such as nails or screws, for adding auxiliary structural items to the concrete form. This is because they are fabricated of a structure which is quite versatile in nature.

More specifically, the reusable concrete form of the present invention is utilized to produce a concrete structure. The concrete form typically comprises a concrete form body portion, which is generally flexible in construction. The concrete form body portion is configurable during use to define a substantially circular or arcuate-shaped workspace. At least one fastener is attached to the concrete form body portion. In an assembled position, the fastener is interlockingly engaged so that the concrete form body portion defines a circular or arcuate-shaped workspace. In the disassembled position, the fastener is disengaged, and the concrete form is in a flattened configuration which is readily storable.

The reusable concrete form, after producing a concrete structure, can be disassembled to produce a flattened configuration. It can then be reassembled in the assembled position and reutilized to produce another concrete structure.

The concrete form body portion preferably comprises an impact-resistant substrate. More preferably, the concrete form body portion comprises a nonmetallic material or a non-cellulosic material.

The concrete form body portion preferably comprises a polymeric material. More preferably, the concrete form body portion comprises a polyolefin material which is typically a polypropylene material. The most preferred polymeric material is ultra-high molecular weight polypropylene.

The reusable concrete form preferably includes at least one fastener which is attachable to the concrete form body at a plurality of locations to produce concrete forms having a plurality of radii. The concrete form body portion is preferably not readily deformable and readily returns to its original circular or arcuate shape. The reusable concrete form preferably defines a workspace which has a constant circular or arcuate shape. Preferably, the concrete form body portion is of a substantially seamless construction.

The reusable concrete form preferably can be installed about an existing structural framework. Moreover, it is preferably readily removable from about the concrete structure after formation thereof.

The reusable concrete form is typically readily storable or transportable outdoors without substantial resultant damage to its structural integrity. The reusable concrete form does not require an underlying concrete pad to be installed to supporting the concrete structure. The reusable concrete form preferably can form concrete structures having multiple heights.

In a preferred aspect of this invention, a method for producing a reusable concrete form for producing a concrete structure is provided. The method comprises providing a concrete form body portion which is generally flexible in construction and which is configurable during use to define a substantially circular or arcuate-shaped workspace. Also, at least one fastener is provided. Then, the fastener is attached to the body portion. The disassembled concrete form is in a flattened configuration which is readily storable. In an assembled position, the fastener system is interlockingly engaged so that the concrete form body portion defines the circular or arcuate-shaped workspace, and in the disassembled position, the fastener is disengaged, and the concrete form is in a flattened configuration which is readily storable.

In another preferred aspect of this invention, a method for producing a concrete structure is provided. This method comprises the steps of providing a disassembled concrete form including a body portion and at least one fastener attached to the body portion. Next, the disassembled concrete form is assembled by interlockingly engaging the fastener so that the body portion defines a workspace having a smooth, circular or arcuate shape. Concrete is poured into the workspace. The concrete is cured within the workspace until it hardens to produce a concrete structure. Then, the concrete form is disassembled from about the concrete structure by disengaging the fastener elements.

### DESCRIPTION OF THE DRAWINGS

FIG. 1 is a schematic, fragmentary plan view of a preferred flexible, lightweight concrete form 10 of the present invention when the fastening elements are not connected for use.

FIG. 2 is a schematic plan view of another preferred flexible, lightweight concrete form 30 of the present invention when the fastening elements are not connected for use.

FIG. 3 is an end view of the flexible, lightweight concrete form 30 of FIG. 2 when the fastening elements are connected for use.

### DETAILED DESCRIPTION OF THE PRESENT INVENTION

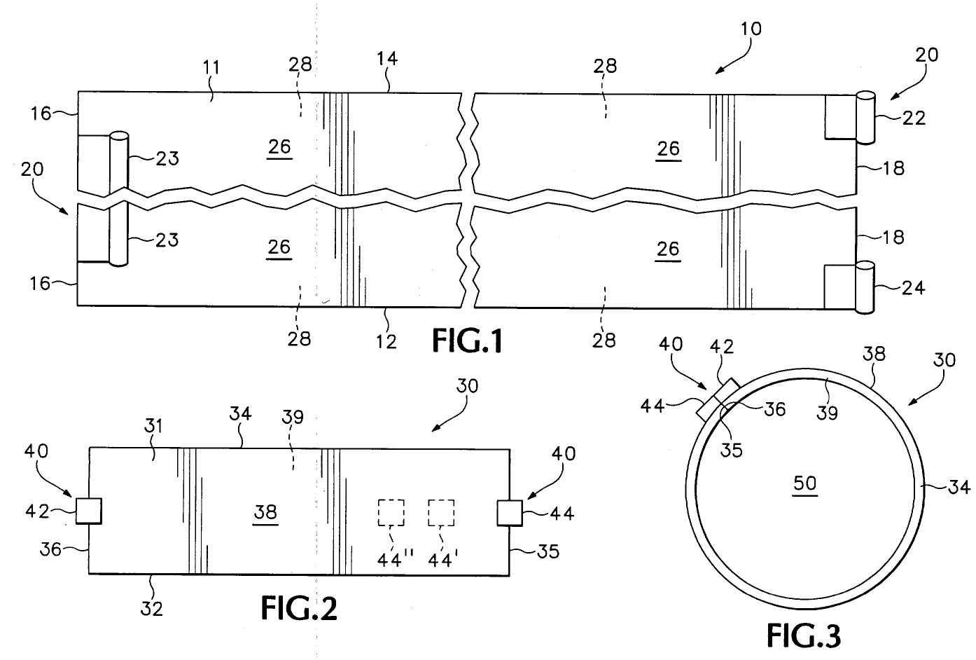

The concrete form of the present invention, denoted “10” in FIG. 1 and “30” in FIGS. 2 and 3, respectively, overcomes the problems described above. The material chosen for producing a concrete form body 11 of concrete form 10 is generally lightweight, flexible, strong, tough, impact-resistant and capable of being configured into a smooth, regular circular or arcuate shape. The concrete form structural body 11 is typically produced of a non-metallic and/or non-cellulosic material. Body 11 can be produced from a flexible, lightweight, strong, tough, impact-resistant polymeric material. A number of polymeric materials can be employed for this purpose. For example, a flexible, lightweight layer of polyolefin material can be used as body 11. Preferably, a flexible, lightweight polypropylene material, more preferably a UHMW polypropylene material, can be utilized in the manufacture of the body 11.

Referring to FIG. 1, a fragmentary plan view of a preferred flexible concrete form 10 is shown to illustrate the apparatus and indicate that it can be fabricated of numerous lengths and widths which is capable of being configured into a smooth, regular circular or arcuate shape of numerous sizes. The form 10 comprises outer surface 26, inner surface 28, respective edges 12 and 14, and respective ends 16 and 18, and is shown in an unassembled position and in a flattened configuration which is readily storable.

When form 10 is configured into a smooth, regular circular shape, end 16 is connected to end 18 using fastener 20, and surfaces 26 and 28 are disposed in a generally circular profile. Fastener 20 can be selected from a large group of commercially available products useful for the purpose described above. As shown in FIG. 1, for purposes of illustration, fastener 20 can comprise fastener element 23 which is joined to end 16, and fastener elements 22 and 24 which are joined to end 18.

Referring to FIG. 2, a plan view of a preferred flexible concrete form 30 is also shown in an unassembled position and in a flattened configuration which is readily storable. The form 30 comprises a concrete body portion 31 including outer surface 38, inner surface 39, respective edges 32 and 34, and respective ends 35 and 36. Fastener 40 comprises fastener element 42 which is joined to end 36 and fastener element 44 which are joined to end 35. In FIG. 2, fastener element 42 and fastener element 44 are not in locking engagement with each other, and the form 30 is in a flattened, easily storable mode. In use (see FIG. 3), fastener element 42 and fastener element 44 are in interlocking engagement one to other. Alternatively, fastener element 44 can be located at positions 44′ and 44″, and joined to outer surface 38, to produce concrete forms of varying diameter.

Referring to FIG. 3, concrete form 30 of FIG. 2 is shown assembled in a generally circular profile, the fastener system 40 being interlockingly engaged so that the concrete form body portion defines said circular-shaped workspace 50. In this assembled arrangement, concrete can be poured into the workspace 50 defined by concrete form 30. Then, the concrete is allowed to cure and harden to a finished circular cross-sectional shaped concrete structure (not shown). When the curing process has been completed, the fastener elements 42 and 44 are disengaged, and the form 30 is disassembled so that it returns to the flattened configuration shown in FIG. 2.

I claim:

1. A reusable concrete form utilized to produce a concrete structure comprising a concrete form body portion which is generally flexible in construction and which is configurable during use to define a substantially circular or arcuate-shaped work space, and at least one fastener attached to the concrete form body portion, in an assembled position, the fastener system is interlockingly engaged so that said concrete form body portion defines said circular or arcuate-shaped workspace, and in the disassembled position, the fastener is disengaged, and the concrete form is in a flattened configuration which is readily storable.

2. The reusable concrete form of claim 1, which after producing a concrete structure, can be disassembled to a flattened configuration, and then reassembled in said assembled position and reutilized to produce another concrete structure.

3. The reusable concrete form of claim 1, wherein said concrete form body portion comprises an impact-resistant substrate.

4. The reusable concrete form of claim 1, wherein said concrete form body portion comprises a non-metallic material.

5. The reusable concrete form of claim 1, wherein said concrete form body portion comprises a non-cellulosic material.

6. The reusable concrete form of claim 1, wherein said concrete form body portion comprises a polymeric material.

7. The reusable concrete form of claim 1, wherein said concrete form body portion comprises a polyolefin material.

8. The reusable concrete form of claim 1, wherein said concrete form body portion comprises a polypropylene material.

9. The reusable concrete form of claim 1, wherein said fastener is attachable to concrete form body at a plurality of locations to produce concrete forms having a plurality of radii.

10. The reusable concrete form of claim 1, which is readily removable from about the concrete structure after formation thereof.

11. The reusable concrete form of claim 1, wherein said workspace has a constant circular or arcuate shape.

12. The reusable concrete form of claim 1, wherein said concrete form body portion is not readily deformable and readily returns to its original circular or arcuate shape.

13. The reusable concrete form of claim 1, wherein said concrete form body portion is of a substantially seamless construction.

14. The reusable concrete form of claim 1, which is readily storable or transportable outdoors without substantial resultant damage to its structural integrity.

15. The reusable concrete form of claim 1, which can be installed about an existing structural framework.

16. The reusable concrete form of claim 1, which does not require an underlying concrete pad to be installed to supporting the concrete structure.

17. The reusable concrete form of claim 1, which can form concrete structures having multiple heights.

18. The reusable concrete form of claim 1, wherein said concrete form body portion comprises ultra-high molecular weight polypropylene.

19. A method for producing a reusable concrete form for producing a concrete structure comprising the steps of
providing a concrete form body portion which is generally flexible in construction and which is configurable during use to define a substantially circular or arcuate-shaped workspace;
providing at least one fastener; and
attaching the fastener to the body portion, the disassembled concrete form being in a flattened configuration which is readily storable,
in an assembled position, the fastener system is interlockingly engaged so that said concrete form body portion defines said circular or arcuate-shaped workspace, and in the disassembled position, the fastener is disengaged, and the concrete form is in a flattened configuration which is readily storable.

20. A method for producing a concrete structure comprising the steps of providing a disassembled concrete form including a body portion and at least one fastener attached to the body portion;
assembling the disassembled concrete form by interlockingly engaging the fastener so that said body portion defines a workspace having a smooth, circular or arcuate shape;
pouring concrete into the workspace;
curing the concrete within the workspace until it hardens to produce a concrete structure; and
disassembling the concrete form from about the concrete structure by disengaging the fastener elements.
